(19) United States
(12) Patent Application Publication
(10) Pub. No.: US 2026/0196558 A1
(43) Pub. Date: Jul. 9, 2026

(54) ADDITIVE, ELECTROLYTE FOR RECHARGEABLE LITHIUM BATTERY, POSITIVE ELECTRODE, AND RECHARGEABLE LITHIUM BATTERY INCLUDING THE SAME

(71) Applicant: SAMSUNG SDI CO., LTD., Yongin-si, Gyeonggi-do (KR)

(72) Inventors: Hyejin PARK, Yongin-si (KR); Wonseok CHO, Yongin-si (KR); Tae Jin LEE, Yongin-si (KR); Sangwoo PARK, Yongin-si (KR); Minseo KIM, Yongin-si (KR); Myungheui WOO, Yongin-si (KR); Sanghoon KIM, Yongin-si (KR); Hana RA, Yongin-si (KR); Bokyung RYU, Yongin-si (KR)

(21) Appl. No.: 18/865,538

(22) PCT Filed: Nov. 11, 2022
(86) PCT No.: PCT/KR2022/017753

§ 371 Date: Nov. 13, 2024

(30) Foreign Application Priority Data
May 20, 2022 (KR) 10-2022-0062278

(51) Int. Cl. H01M 10/0567; H01M 4/02; H01M 4/36; H01M 4/38; H01M 4/525; H01M 4/583

(52) U.S. Cl. CPC H01M 10/0567; H01M 4/366; H01M 4/386; H01M 4/525; H01M 4/583; H01M 2004/021; H01M 2004/027; H01M 2004/028

(57) ABSTRACT

Provided are an additive represented by Chemical Formula 1, an electrolyte and a positive electrode for a rechargeable lithium including the additive, and a rechargeable lithium battery.

Details regarding Chemical Formula 1 are as described in the specification.

### TECHNICAL FIELD

This disclosure relates to an additive, an electrolyte and a positive electrode for a rechargeable lithium battery including the same, and a rechargeable lithium battery including the same.

### BACKGROUND ART

A rechargeable lithium battery may be recharged and has three or more times as high energy density per unit weight as a conventional lead storage battery, nickel-cadmium battery, nickel hydrogen battery, nickel zinc battery and the like. It may be also charged at a high rate and thus, is commercially manufactured for a laptop, a cell phone, an electric tool, an electric bike, and the like, and researches on improvement of additional energy density have been actively made.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

The electrolyte serves as a medium for moving lithium ions between should have viscosity stability according to time. If the positive electrode slurry composition is not uniformly coated on the current collector, there may be no uniform battery chemical reaction, which may lead to thickness variation of the electrode and thus, bring about problems such as deformation of the electrode and peeling of the active material during charging and discharging.

### DISCLOSURE

### Technical Problem

An embodiment provides an additive having improved high-temperature characteristics.

Another embodiment provides an electrolyte for a rechargeable lithium battery including the additive.

Another embodiment provides a positive electrode including the additive.

Another embodiment is to provide a rechargeable lithium battery with improved high-temperature storage characteristics by applying the electrolyte or positive electrode.

### Technical Solution

An embodiment of the present invention provides an additive represented by Chemical Formula 1.

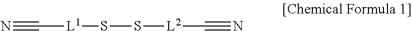

In Chemical Formula 1,
L¹ and L² are each independently a substituted or unsubstituted C1 to C20 alkylene group.

L¹ and L² may each independently be a substituted or unsubstituted C1 to C10 alkylene group.

Chemical Formula 1 may be represented by Chemical Formula 1-1.

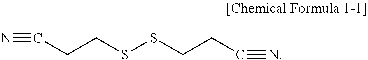

Another embodiment of the present invention provides an electrolyte for a rechargeable lithium battery including a non-aqueous organic solvent, a lithium salt, and the additive.

The additive may be included in an amount of 0.1 to 10 parts by weight based on 100 parts by weight of the electrolyte for a rechargeable lithium battery.

The additive may be included in an amount of 0.1 to 5 parts by weight based on 100 parts by weight of the electrolyte for a rechargeable lithium battery.

The additive may further include least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexanetricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

Another embodiment of the present invention provides a rechargeable lithium battery including a positive electrode including a positive electrode active material; a negative electrode including a negative electrode active material; and the aforementioned electrolyte for a rechargeable lithium battery.

Another embodiment of the present invention provides a positive electrode including a positive electrode active material, a binder, a conductive agent, and the additive.

The additive may be included in an amount of 0.001 to 0.05 parts by based on 100 parts by weight of a total of the positive electrode active material, binder, and conductive agent.

The positive electrode active material may be represented by Chemical Formula 3.

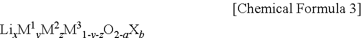

In Chemical Formula 3,
0.5≤x≤1.8, 0≤a≤0.05, 0≤b≤0.05, 0<y≤1, 0≤z≤1, 0≤y+z≤1, M¹, M², and M³ each independently include at least one element selected from a metal of Ni, Co, Mn, Al, B, Ba, Ca, Ce, Cr, Fe, Mo, Nb, Si, Sr, Mg, Ti, V, W, Zr, or La, and a combination thereof, and X includes at least one element selected from F, S, P, or Cl.

In Chemical Formula 3, 0.8≤y≤1, 0≤z≤0.2, and M¹ may be Ni.

Another embodiment of the present invention provides a rechargeable lithium battery including the aforementioned positive electrode; a negative electrode including a negative electrode active material; and an electrolyte for a rechargeable lithium battery.

The rechargeable lithium battery further includes a positive electrode film on the surface of the positive electrode, and
the positive electrode film may be a complex compound formed by coordinating an additive represented by Chemical Formula 1 to the positive electrode active material.

The negative electrode active material may include at least one of graphite and a Si composite.

The Si composite may include a core including Si-based particles and an amorphous carbon coating layer.

The Si-based particles may include at least one of silicon particles, Si—C composites, SiOₓ (0<x≤2), and a Si alloy.

The core including the Si-based particles may include a pore at the central portion.

A radius of the central portion corresponds to 30% to 50% of the radius of the Si composite, the average particle diameter of the Si composite may be 5 μm to 20 μm, and the average particle diameter of the Si-based particles may be 10 nm to 200 nm.

The core including the Si-based particles includes amorphous carbon, the central portion does not include amorphous carbon, and the amorphous carbon may exist only in the surface portion of the Si composite.

The negative electrode active material may further include crystalline carbon.

### Advantageous Effects

By suppressing the breakdown of the positive electrode active material, an increase in the resistance of the battery during high-temperature storage can be suppressed, and the amount of gas generated can be reduced, thereby realizing a rechargeable lithium battery with improved high-temperature characteristics.

### DESCRIPTION OF THE DRAWINGS

FIG. 1 is a schematic view showing a rechargeable lithium battery according to an embodiment.

FIG. 2 is a graph showing the results of measuring the amount of gas generated after high-temperature storage for Examples 1 to 9 and Comparative Examples 1 to 7.

FIG. 3 is a graph showing the results of measuring DC resistance after high-temperature storage for Examples 1 to 9 and Comparative Examples 1 to 7.

FIG. 4 shows the XPS analysis results for the positive electrode of a rechargeable lithium battery cell manufactured according to Comparative Example 1.

FIG. 5 shows the XPS analysis results for the positive electrodes of rechargeable lithium battery cells manufactured according to Examples 1 to 3.

### DESCRIPTION OF SYMBOLS

100: rechargeable lithium battery
112: negative electrode
113: separator
114: positive electrode
120: battery case
140: sealing member

### BEST MODE

Hereinafter, a rechargeable lithium battery according to an embodiment of the present invention will be described in detail with reference to the accompanying drawings. However, these embodiments are exemplary, the present invention is not limited thereto and the present invention is defined by the scope of claims.

In the present specification, when a definition is not otherwise provided, “substituted” refers to replacement of at least one hydrogen of a substituent or a compound by deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 trifluoroalkyl group, a cyano group, or a combination thereof.

In one example of the present invention, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In addition, in specific examples of the present invention, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. In addition, in specific examples of the present invention, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In addition, in specific examples of the present invention, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

A rechargeable lithium battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it may be bulk type and thin film type depending on sizes. Structures and manufacturing methods for lithium ion batteries pertaining to this disclosure are well known in the art.

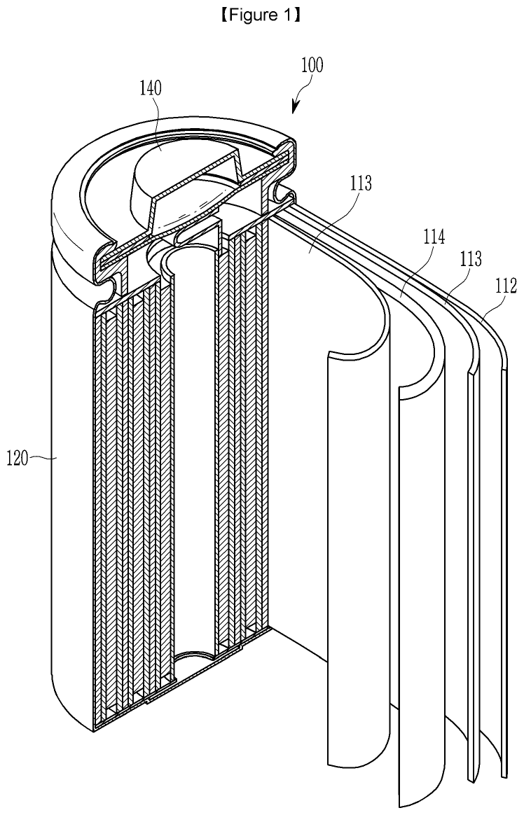

Herein, a cylindrical rechargeable lithium battery will be exemplarily described as an example of the rechargeable lithium battery. FIG. 1 schematically shows the structure of a rechargeable lithium battery according to an embodiment. Referring to FIG. 1, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte (not shown) impregnating the positive electrode 114, the negative electrode 112, and the separator 113, a battery case 120 housing the battery cell, and a sealing member 140 sealing the battery case 120.

Hereinafter, an additive according to an embodiment will be described.

An additive according to an embodiment of the present invention is represented by Chemical Formula 1.

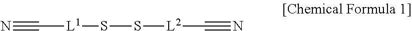

In Chemical Formula 1,
L¹ and L² are each independently a substituted or unsubstituted C1 to C20 alkylene group.

For example, L¹ and L² may each independently be a substituted or unsubstituted C1 to C10 alkylene group, specifically a substituted or unsubstituted C2 to C10 alkylene group, and more specifically a substituted or unsubstituted C2 to C5 alkylene group.

For example, L¹ and L² may each independently be a substituted or unsubstituted ethylene group, a substituted or unsubstituted propylene group, or a substituted or unsubstituted butylene group.

In an embodiment, Chemical Formula 1 may be represented by Chemical Formula 1-1.

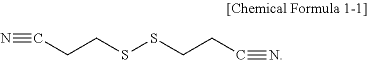

The additive can form a film on the surface of the positive electrode by combining with and coordinating the positive electrode active material, thereby suppressing the breakdown of the positive electrode active material.

The additive may be included as an additive of an electrolyte for a rechargeable lithium battery or as an additive of a positive electrode.

The electrolyte for a rechargeable lithium battery according to another embodiment includes a non-aqueous organic solvent, a lithium salt, and the aforementioned additive.

The additive may be included in an amount of 0.1 to 10 parts by weight based on 100 parts by weight of the electrolyte for a rechargeable lithium battery.

For example, the additive may be included in an amount of 0.1 to 5.0 parts by weight based on 100 parts by weight of the electrolyte for a rechargeable lithium battery.

When the content range of the additive is as described above, a rechargeable lithium battery with improved cycle-life characteristics and output characteristics can be implemented by preventing an increase in resistance at high temperatures.

The additive may further include least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexanetricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

By further including the aforementioned other additives, cycle-life may be further improved or gas generated from the positive electrode and negative electrode during high-temperature storage may be effectively controlled.

The other additives may be included in an amount of 0.2 to 20 parts by weight, specifically 0.2 to 15 parts by weight, for example, 0.2 to 10 parts by weight, based on 100 parts by weight of the electrolyte for a rechargeable lithium battery.

When the content of other additives is as described above, battery performance may be improved by minimizing an increase in film resistance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethyl methyl carbonate (EMC), ethylene carbonate (EC), propylene carbonate (PC), butylene carbonate (BC), and the like. The ester-based solvent may include methyl acetate, ethyl acetate, n-propyl acetate, t-butyl acetate, methylpropionate, ethylpropionate, propylpropionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R¹—CN (wherein R¹ is a hydrocarbon group having a C2 to C20 linear, branched, or cyclic structure and may include a double bond, an aromatic ring, or an ether bond), and the like, dioxolanes such as 1,3-dioxolane and the like, sulfolanes, and the like.

The non-aqueous organic solvents may be used alone or in combination of one or more, and when using one or more in combination, the mixing ratio may be appropriately adjusted depending on the desired battery performance, which is widely understood by those working in the relevant field.

The carbonate-based solvent is prepared by mixing a cyclic carbonate and a linear carbonate. When the cyclic carbonate and linear carbonate are mixed together in a volume ratio of 1:9 to 9:1, an electrolyte performance may be improved.

In particular, in an embodiment of the present invention, the non-aqueous organic solvent may include the cyclic carbonate and the chain carbonate in a volume ratio of 2:8 to 5:5, and as a specific example, the cyclic carbonate and the chain carbonate may be included in a volume ratio of 2:8 to 4:6.

As a more specific example, the cyclic carbonate and the chain carbonate may be included in a volume ratio of 2:8 to 3:7.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 2.

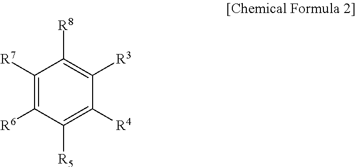

In Chemical Formula 2, R³ to R⁸ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt dissolved in the non-aqueous organic solvent supplies lithium ions in a battery, enables a basic operation of a rechargeable lithium battery, and improves transportation of the lithium ions between positive and negative electrodes. Examples of the lithium salt include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein, x and y are natural numbers, for example, integers ranging from 1 to 20, LiCl, LiI, LiB(C₂O₄)₂ (lithium bis(oxalato)borate: LiBOB), LiDFOB (lithium difluoro (oxalato) borate), and Li[PF₂(C₂O₄)₂] (lithium difluoro (bis oxalato)phosphate). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Another embodiment provides a rechargeable lithium battery including a positive electrode including a positive electrode active material; a negative electrode including a negative electrode active material; and the aforementioned electrolyte.

The positive electrode includes a positive electrode current collector and a positive electrode active material layer on the positive electrode current collector, wherein the positive electrode active material layer includes a positive electrode active material.

As the positive electrode active material, a compound capable of intercalating and deintercalating lithium (lithiated intercalation compound) may be used.

Specifically, at least one compound oxide of lithium and a metal selected from cobalt, manganese, nickel, and combinations thereof may be used.

Of course, a part of the metal of the composite oxide may be replaced with a metal other than another metal, and the composite oxide may be at least one selected from a phosphate compound, for example, LiFePO₄, LiCoPO₄, and LiMnPO₄, and a composite oxide having a coating layer on the surface thereof may also be used, or a composite oxide and a composite oxide having a coating layer may be mixed and used. The coating layer may include at least one coating element compound selected from an oxide of a coating element, a hydroxide of a coating element, an oxyhydroxide of a coating element, an oxycarbonate of a coating element, and a hydroxy carbonate of a coating element.

The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. For example, the method may include any coating method (e.g., spray coating, dipping, etc.), but is not illustrated in more detail since it is well-known to those skilled in the related field.

The positive electrode active material may be, for example, at least one of lithium composite oxides represented by Chemical Formula 3.

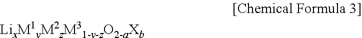

In Chemical Formula 3,
0.5≤x≤1.8, 0≤a≤0.05, 0≤b≤0.05, 0<y≤1, 0≤z≤1, 0≤y+z≤1, M¹, M², and M³ each independently include at least one element selected from a metal of Ni, Co, Mn, Al, B, Ba, Ca, Ce, Cr, Fe, Mo, Nb, Si, Sr, Mg, Ti, V, W, Zr, or La, and a combination thereof, and X includes at least one element selected from F, S, P, or Cl.

In an embodiment, the positive electrode active material may be at least one selected from LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1).

In Chemical Formula 3, 0.8≤y≤1, 0≤z≤0.2, and M¹ may be Ni.

For example, the positive electrode active material selected from the LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1) may be a high nickel (high Ni)-based positive electrode active material.

For example, in the case of the LiNiₐMn_{b}Co_{c}O₂ (a+b+c=1) and LiNiₐMn_{b}Co_{c}Al_{d}O₂ (a+b+c+d=1), the nickel content may be 60% or more (a≥0.6), and more specifically, 80% or more (a≥0.8).

For example, in the case of the LiNiₑCo_{f}Al_{g}O₂ (e+f+g=1), the nickel content can be 60% or more (e≥0.6), and more specifically, 80% or more (e≥0.8).

The positive electrode active material may be included in an amount of 90 wt % to 98 wt % based on a total weight of the positive electrode active material layer.

In an embodiment of the present invention, the positive electrode active material layer may optionally include a conductive material and a binder. At this time, a content of the conductive material and the binder may be 1 wt % to 5 wt %, respectively, based on the total weight of the positive electrode active material layer.

The conductive material is used to provide conductivity to the positive electrode and any electrically conductive material may be used as a conductive material unless it causes a chemical change and examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Al may be used as the positive electrode current collector, but is not limited thereto.

The positive electrode may further include the aforementioned additive.

The additive may be included in an amount of 0.001 to 0.05 parts by based on 100 parts by weight of a total of the positive electrode active material, binder, and conductive agent.

For example, the additive may be included in an amount of 0.002 to 0.01 parts by weight based on 100 parts by weight of a total of the positive electrode active material, binder, and conductive agent.

The additive may improve high-temperature storage characteristics by bonding with the positive electrode active material to form a film on the surface of the positive electrode, and especially when added in the above content, the degree of improvement in gas generation may be significantly exhibited without increasing resistance.

The additive may be applied to the electrolyte or the positive electrode to form a positive electrode film.

The positive electrode film may be a complex compound formed by coordinating an additive represented by Chemical Formula 1 to the positive electrode active material.

More specifically, the positive electrode film may be formed by forming a complex between the unshared electron pair of the disulfide of the additive and the metal of the positive electrode active material, or by forming a complex between the nitrile of the additive and the metal of the positive electrode active material, or by simultaneously forming a complex between the unshared electron pair of the disulfide of the additive and the metal of the positive electrode active material, and by fixing the complex to the positive electrode surface.

In particular, when applied to the positive electrode, the additive is first bonded with the positive electrode active material before participating in the electrochemical reaction, so that the amount of positive electrode film produced can be further increased.

The negative electrode includes a negative electrode current collector and a negative electrode active material layer including a negative electrode active material formed on the negative electrode current collector.

The negative electrode active material may include a material that reversibly intercalates/deintercalates lithium ions, lithium metal, lithium metal alloy, material being capable of doping/dedoping lithium, or a transition metal oxide.

The material that reversibly intercalates/deintercalates lithium ions may include a carbon material. The carbon material may be any generally-used carbon-based negative electrode active material in a rechargeable lithium battery. Examples thereof may be crystalline carbon, amorphous carbon, or a mixture thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, fired coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, a Si—C composite, SiOₓ (0<x<2), a Si-Q alloy wherein Q is an element selected from an alkali metal, an alkaline-earth metal, a Group 13 element, a Group 14 element, a Group 15 element, a Group 16 element, a transition metal, a rare earth element, and a combination thereof, and not Si), Sn, SnO₂, a Sn—R¹¹ alloy (wherein R¹¹ is an element selected from an alkali metal, an alkaline-earth metal, a Group 13 element, a Group 14 element, a Group 15 element, a Group 16 element, a transition metal, a rare earth element, and a combination thereof, and not Sn), and the like. At least one of these materials may be mixed with SiO₂.

The elements Q and R¹¹ may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The transition metal oxide may be vanadium oxide, lithium vanadium oxide, or lithium titanium oxide.

In a specific embodiment, the negative electrode active material may include at least one of graphite and a Si composite.

The Si composite may include a core including Si-based particles and amorphous carbon, and for example, the Si-based particles may include at least one of silicon particles, a Si—C composite, SiOₓ (0<x≤2), and a Si alloy.

For example, the core including the Si-based particles may include a pore at the central portion, the radius of the central portion corresponding to 30% to 50% of the radius of the Si composite, the average particle diameter of the Si composite may be 5 μm to 20 μm, and the average particle diameter of the Si-based particles may be 10 nm to 200 nm.

In the present specification, the average particle diameter may be a particle size (D50) at 50% by volume in a cumulative size-distribution curve.

When the average particle diameter of the Si-based particle is within the above range, volume expansion occurring during charging and discharging may be suppressed, and a break in a conductive path due to particle crushing during charging and discharging may be prevented.

The core including the Si-based particles may further include amorphous carbon, wherein the central portion does not include amorphous carbon, and the amorphous carbon may exist only in the surface portion of the Si composite.

At this time, the surface portion means an area from the outermost surface of the central portion to the outermost surface of the Si composite.

In addition, the Si-based particles are substantially uniformly included over the negative electrode active material, that is, present at a substantially uniform concentration in the central portion and the surface portion thereof.

The amorphous carbon may be soft carbon, hard carbon, mesophase pitch carbonized product, calcined coke, or a combination thereof.

For example, the Si—C composite may include silicon particles and crystalline carbon.

The silicon particles may be included in an amount of 1 to 60 wt %, for example, 3 to 60 wt % based on the total weight of the Si—C composite.

The crystalline carbon may be, for example, graphite, and specifically may be natural graphite, artificial graphite, or a combination thereof.

An average particle diameter of the crystalline carbon may be 5 μm to 30 μm.

When the negative electrode active material includes both graphite and Si composite, the graphite and Si composite may be included in the form of a mixture, in which case the graphite and Si composite may be included in a weight ratio of 99:1 to 50:50.

More specifically, the graphite and Si composite may be included in a weight ratio of 97:3 to 80:20, or 95:5 to 80:20.

The amorphous carbon precursor may include a coal-based pitch, mesophase pitch, petroleum-based pitch, coal-based oil, petroleum-based heavy oil, or a polymer resin such as a phenol resin, a furan resin, or a polyimide resin.

In the negative electrode active material layer, the negative electrode active material may be included in an amount of 95 wt % to 99 wt % based on the total weight of the negative electrode active material layer.

In an embodiment of the present invention, the negative electrode active material layer includes a binder, and optionally a conductive material. In the negative electrode active material layer, a content of the binder may be 1 wt % to 5 wt % based on a total weight of the negative electrode active material layer. When the negative electrode active material layer further includes a conductive material, the negative electrode active material layer includes 90 wt % to 98 wt % of the negative electrode active material, 1 wt % to 5 wt % of the binder, and 1 wt % to 5 wt % of the conductive material.

The binder improves binding properties of negative electrode active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, an ethylene propylene copolymer, polyethyleneoxide, polyvinylpyrrolidone, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 to 3 parts by weight based on 100 parts by weight of the negative electrode active material.

The conductive material is included to provide electrode conductivity. Any electronically conductive material may be used as a conductive material unless it causes a chemical change in a battery. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

Another embodiment of the present invention provides a rechargeable lithium battery including the aforementioned positive electrode; a negative electrode including a negative electrode active material; and an electrolyte for a rechargeable lithium battery.

The negative electrode active material is as described above, and the electrolyte for a rechargeable lithium battery includes a non-aqueous organic solvent and a lithium salt, and the non-aqueous organic solvent and the lithium salt are as described above.

The rechargeable lithium battery may further include a separator between the negative electrode and the positive electrode, depending on a type of the battery. Such a separator may be a porous substrate; or composite porous substrates.

The porous substrate is a substrate that includes a pore through which lithium ions can move. The porous substrate may include for example polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The composite porous substrate may have a form including a porous substrate and a functional layer on the porous substrate. The functional layer may be, for example, at least one of a heat-resistant layer and an adhesive layer from the viewpoint of enabling additional function. For example, the heat-resistant layer may include a heat-resistant resin and optionally a filler.

In addition, the adhesive layer may include an adhesive resin and optionally a filler.

The filler may be an organic filler or an inorganic filler.

### MODE FOR INVENTION

Hereinafter, examples and comparative examples are described. These examples, however, are not in any sense to be interpreted as limiting the scope of the invention.

### Manufacturing of Rechargeable Lithium Battery Cell

### Comparative Example 1

Positive electrode active material slurry was prepared by using LiNi_{0.88}Co_{0.07}Al_{0.05}O₂ as a positive electrode active material, polyvinylidene fluoride as a binder, and ketjen black as a conductive material in a weight ratio of 96:2:2 and dispersing the mixture in N-methyl pyrrolidone.

The positive electrode active material slurry was coated on a 14 μm-thick Al foil, dried at 100° C., and pressed to manufacture a positive electrode.

A negative electrode active material was prepared by mixing artificial graphite and an Si—C composite in a weight ratio of 93:7, and then the negative electrode active material, a styrene-butadiene rubber binder as a binder, and carboxylmethyl cellulose as a thickener were mixed in a weight ratio of 97:1:2 and then, dispersed in distilled water to prepare a negative electrode active material slurry.

The Si—C composite was in a form of a core including artificial graphite and silicon particles and a coal-based pitch coated on the surface of the core.

The negative electrode active material slurry was coated on a 10 μm-thick Cu foil, dried at 100° C., and pressed to manufacture a negative electrode.

An electrode assembly was manufactured by assembling the manufactured positive and negative electrodes, and a separator made of polyethylene having a thickness of 25 μm, and an electrolyte was injected to manufacture a rechargeable lithium battery cell.

The electrolyte has a following composition.

### (Composition of Electrolyte)

Salt: LiPF₆ 1.15 M
Solvent:ethylene carbonate:ethyl methyl carbonate:dimethyl carbonate (EC:EMC:DMC=volume ratio of 20:40:40)
Other additives: 1 part by weight of vinylene carbonate (VC) and 1 part by weight of LiPO₂F₂

(In the composition of the electrolyte, “parts by weight” means the relative weight of the additive based on 100 weight of the total electrolyte (lithium salt+non-aqueous organic solvent.)

### Example 1

A rechargeable lithium battery cell was manufactured in the same method as in Comparative Example 1 except that 0.2 parts by weight of oxalic acid and 0.01 parts by weight of an additive represented by Chemical Formula 1-1, based on 100 parts by weight of the total of the positive electrode active material, the binder, and the conductive agent, were dispersed in N-methyl pyrrolidone.

### Examples 2 to 4 and Comparative Examples 2 and 3

Each rechargeable lithium battery cell was manufactured in the same method as in Example 1 except that the content of the additive represented by Chemical Formula 1-1 was changed as shown in Table 1.

### Examples 5 to 9 and Comparative Examples 4 and 5

Each rechargeable lithium battery cell was manufactured in the same method as in Example 1 except that the additive represented by Chemical Formula 1-1 was added to the electrolyte in each content shown in Table 1.

### Comparative Example 6

A rechargeable lithium battery cell was manufactured in the same method as in Comparative Example 1 except that an additive represented by Chemical Formula a was added in an content shown in Table 1.

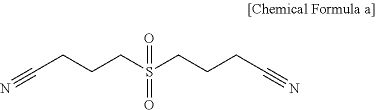 [SMILES: N#CCCCS(=O)(=O)CCCC#N]

### Comparative Example 7

A rechargeable lithium battery cell was manufactured in the same method as in Example 1 except that the additive represented by Chemical Formula a was added in an content shown in Table 1.

TABLE 1

| | Additive for positive | | Additive for | |
|---|---|---|---|---|
| | electrode composition | | electrolyte | |
| | Chemical | | Chemical | |
| | Formula | Chemical | Formula | Chemical |
| | 1-1 | Formula a | 1-1 | Formula a |
| | (parts by | (parts by | (parts by | (parts by |
| | weight) | weight) | weight) | weight) |
| Comparative Example 1 | — | — | — | — |
| Comparative Example 2 | 0.0001 | — | — | — |
| Comparative Example 3 | 0.1 | — | — | — |
| Comparative Example 4 | — | — | 0.01 | — |
| Comparative Example 5 | — | — | 10 | — |
| Comparative Example 6 | | 0.01 | — | — |
| Comparative Example 7 | | — | — | 0.1 |
| Example 1 | 0.01 | — | — | — |
| Example 2 | 0.008 | — | — | — |
| Example 3 | 0.004 | — | — | — |
| Example 4 | 0.002 | — | — | — |
| Example 5 | — | — | 0.1 | — |
| Example 6 | — | — | 0.5 | — |
| Example 7 | — | — | 1.0 | — |
| Example 8 | — | — | 3.0 | — |
| Example 9 | — | — | 5.0 | — |

Evaluation 1: Measurement of Amount of Gas Generated after High-Temperature Storage

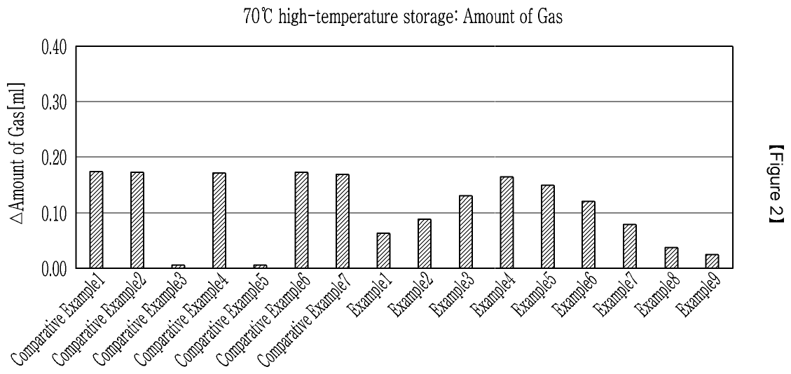

The rechargeable lithium battery cells according to Examples 1 to 9 and Comparative Examples 1 to 7 were allowed to stand at 70° C. for 30 days and then, measured with respect to an amount of gas generated at the 30th day by using a refinery gas analyzer (RGA), and the results of Examples 1 to 9 and Comparative Examples 1 to 7 are shown in FIG. 2.

FIG. 2 is a graph showing the results of measuring the amount of gas generated after high-temperature storage for Examples 1 to 9 and Comparative Examples 1 to 7.

Referring to FIG. 2, when the additive according to the present invention was included in the positive electrode composition or added to the electrolyte in an appropriate amount, the gas generation amount was significantly reduced, improving storage characteristics at a high temperature.

Evaluation 2: Evaluation of Increase Rate of DC Resistance after High-Temperature Storage

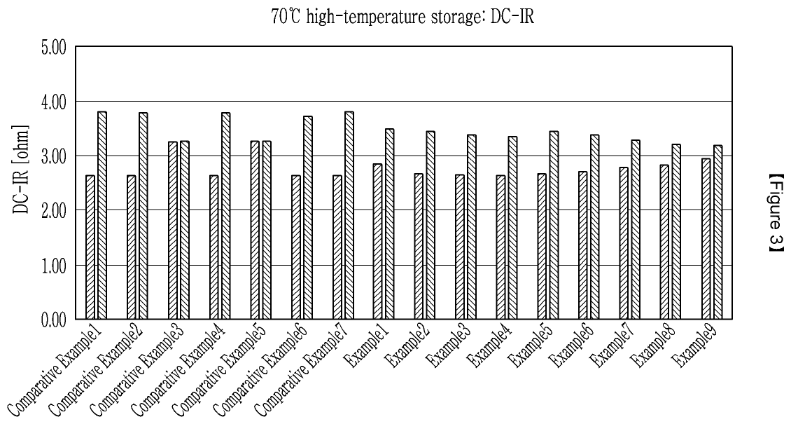

The rechargeable lithium battery cells of Examples 1 to 9 and Comparative Examples 1 to 7 were evaluated with respect to initial DC internal resistance (DCIR) by measuring ΔV/ΔI (voltage change/current change), and in addition, after making a maximum energy state inside the cells into a fully charged state (SOC 100%) and storing the cells at a high temperature of 70° C. for 30 days, DC internal resistance thereof was measured again, and the results of Examples 1 to 9 and Comparative Examples 1 to 7 are shown in FIG. 3.

FIG. 3 is a graph showing the results of measuring DC resistance after high-temperature storage for Examples 1 to 9 and Comparative Examples 1 to 7.

Referring to FIG. 3, when the additive according to the present invention was included in the positive electrode composition or added in an appropriate amount to the electrolyte, it was confirmed that an increase degree of the DC internal resistance after stored at a high temperature, compared with the initial DC resistance, was relatively thereby improving storage characteristics at the high temperature.

### Evaluation 3: Analysis of Positive Electrode Film Component

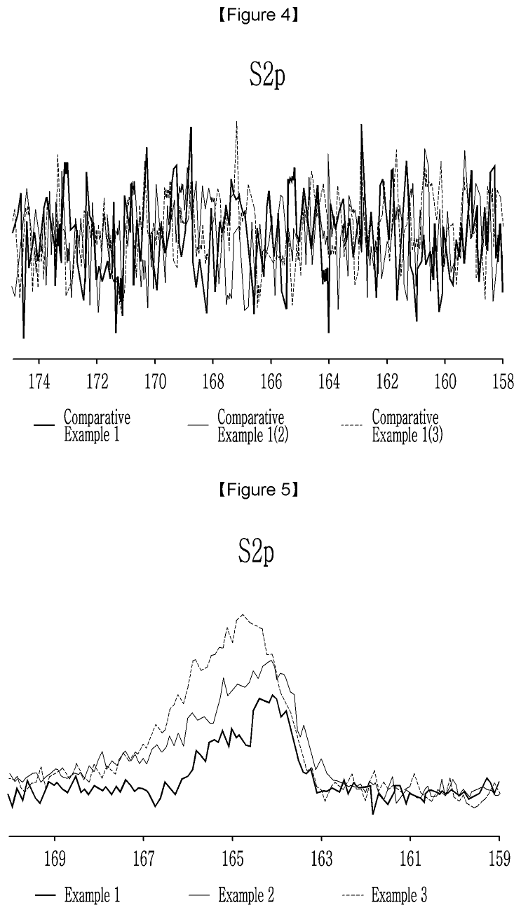

The rechargeable lithium battery cells of Examples 1 to 3 and Comparative Example 1 were subjected to XPS (X-ray Photoelectron Spectroscopy) analysis in order to analyze components of the positive electrode films, and the results are shown in FIGS. 4 and 5.

FIG. 4 shows the XPS analysis result for the positive electrode of the rechargeable lithium battery cell manufactured according to Comparative Example 1.

FIG. 5 shows the XPS analysis results for the positive electrodes of the rechargeable lithium battery cells manufactured according to Examples 1 to 3.

Referring to FIG. 5, Examples 1 to 3 exhibited an S2p peak at binding energy of around 163 eV to 165 eV, but referring to FIG. 4, Comparative Example 1 exhibited no S2p peak.

Accordingly, the rechargeable lithium battery cells according to the present embodiments were confirmed that the additive included in the positive electrode composition was coordinated on the positive electrode surface to form films.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An additive represented by Chemical Formula 1: 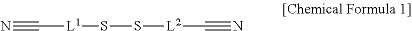
wherein, in Chemical Formula 1,
L¹ and L² are each independently a substituted or unsubstituted C1 to C20 alkylene group.

2. The additive as claimed in claim 1, wherein
L¹ and L² are each independently a substituted or unsubstituted C1 to C10 alkylene group.

3. The additive as claimed in claim 1, wherein
the additive is represented by Chemical Formula 1-1:

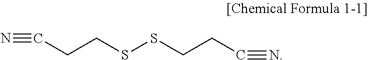

4. An electrolyte for a rechargeable lithium battery, comprising
an electrolyte including a non-aqueous organic solvent, a lithium salt, and the additive of claim 1.

5. The electrolyte for a rechargeable lithium battery as claimed in claim 4, wherein
the additive is included in an amount of 0.1 to 10 parts by weight based on 100 parts by weight of the electrolyte for a rechargeable lithium battery.

6. The electrolyte for a rechargeable lithium battery as claimed in claim 5, wherein
the additive is included in an amount of 0.1 to 5.0 parts by weight based on 100 parts by weight of the electrolyte for a rechargeable lithium battery.

7. The electrolyte for a rechargeable lithium battery as claimed in claim 5, wherein
the additive further comprises least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexanetricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

8. A rechargeable lithium battery, comprising
a positive electrode including a positive electrode active material;
a negative electrode including a negative electrode active material; and
the electrolyte for a rechargeable lithium battery as claimed in claim 4.

9. A positive electrode, comprising
a positive electrode active material, a binder, a conductive material, and an additive as claimed in claim 1.

10. The positive electrode as claimed in claim 9, wherein
the additive is included in an amount of 0.001 to 0.05 parts by based on 100 parts by weight of a total of the positive electrode active material, binder, and conductive agent.

11. The positive electrode as claimed in claim 10, wherein
the positive electrode active material is represented by Chemical Formula 3: 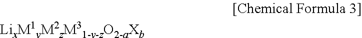
wherein, in Chemical Formula 3,
0.5≤x≤1.8, 0≤a≤0.05, 0≤b≤0.05, 0<y≤1, 0≤z≤1, 0≤y+z≤1, M¹, M², and M³ each independently comprise at least one element selected from a metal of Ni, Co, Mn, Al, B, Ba, Ca, Ce, Cr, Fe, Mo, Nb, Si, Sr, Mg, Ti, V, W, Zr, or La, and a combination thereof, and X comprises at least one element selected from F, S, P, or Cl.

12. The positive electrode as claimed in claim 11, wherein
in Chemical Formula 3,
0.8≤y≤1, 0≤z≤0.2, and M¹ is Ni.

13. A rechargeable lithium battery, comprising
the positive electrode as claimed in claim 9;
a negative electrode including a negative electrode active material; and
an electrolyte for a rechargeable lithium battery.

14. The rechargeable lithium battery as claimed in claim 13, wherein
the positive electrode further comprises a positive electrode film thereon, and
the positive electrode film is a complex compound formed by coordinating an additive represented by Chemical Formula 1 to the positive electrode active material.

15. The rechargeable lithium battery as claimed in claim 13, wherein
the negative electrode active material comprises at least one of graphite and a Si composite.

16. The rechargeable lithium battery as claimed in claim 15, wherein
the Si composite includes a core including Si-based particles and an amorphous carbon coating layer.

17. The rechargeable lithium battery as claimed in claim 16, wherein
the Si-based particles comprise at least one of silicon particles, Si—C composite, SiOₓ (0<x≤2), and a Si alloy.

18. The rechargeable lithium battery as claimed in claim 17, wherein
the core including the Si-based particles comprises a pore at a central portion.

19. The rechargeable lithium battery as claimed in claim 18, wherein
a radius of the central portion corresponds to 30% to 50% of a radius of the Si composite,
an average particle diameter of the Si composite is 5 μm to 20 μm,
an average particle diameter of the Si-based particles is 10 nm to 200 nm.

20. The rechargeable lithium battery as claimed in claim 18, wherein
the core including the Si-based particles comprises amorphous carbon, and
the central region does not comprise amorphous carbon, and the amorphous carbon exist only in the surface portion of the Si composite.

21. The rechargeable lithium battery as claimed in claim 17, wherein
the negative electrode active material further comprises crystalline carbon.
